(19) United States
(12) Patent Application Publication
(10) Pub. No.: US 2014/0204609 A1
(43) Pub. Date: Jul. 24, 2014

(54) DISPLAY DEVICE INCLUDING BACKLIGHT ASSEMBLY

(71) Applicant: Samsung Display Co., Ltd., Yongin-City (KR)

(72) Inventors: Junghoon SHIN, Seongnam-si, Gyeonggi-do (KR); Myung-Seok KWON, Seongnam-si, Gyeonggi-do (KR); YOUNGCHUN KIM, Seoul (KR); Young-Min PARK, Hwaseong-si, Gyeonggi-do (KR)

(21) Appl. No.: 13/905,348

(22) Filed: May 30, 2013

(30) Foreign Application Priority Data
Jan. 23, 2013 (KR) 10-2013-0007569

(51) Int. Cl. F21V 8/00

(52) U.S. Cl. CPC G02B 6/0031; G02B 6/0073
USPC 362/609; 362/612

(57) ABSTRACT

A display device includes: a backlight assembly which generates and outputs light; and a display panel which displays an image with the light from the backlight assembly. The backlight assembly includes: a light emitting unit which generates the light; a light guide plate which guides the light provided from the light emitting unit toward the display panel and includes a protruding part which protrudes laterally from the light guide plate from the light guide plate at a first corner thereof; and a reflective member which is on a surface of the protruding part and reflects the light provided from the light emitting unit toward the protruding part and toward a second corner of the light guide plate and the periphery of the second corner.

This application claims priority to Korean Patent Application No. 10-2013-0007569 filed on Jan. 23, 2013, and all the benefits accruing therefrom under 35 U.S.C. §119, the entire contents of which are hereby incorporated by reference.

### BACKGROUND

(1) Field

The invention disclosed herein relates to a display device including a backlight assembly, and more particularly, to a display device including a backlight assembly and a display panel displaying an image by using the light outputted from the backlight assembly.

(2) Description of the Related Art

A display device including a non self-emissive display panel such as a liquid crystal display device includes a backlight assembly outputting light, and the display panel displaying an image using the light from the backlight assembly. The backlight assembly includes a light emitting unit generating light by receiving power from outside the backlight assembly. The backlight assembly generally includes, as a light source of the light emitting unit, a cold cathode fluorescent lamp (“CCFL”) or a light emitting diode (“LED”) package.

When the backlight assembly includes the LED package, after a plurality of the LED packages are mounted on a printed circuit substrate, the plurality of LED packages receives power from the printed circuit substrate and generates and emits light using the power from the printed circuit substrate.

### SUMMARY

One or more exemplary embodiment of the invention provides a display device having improved display quality, which includes a backlight assembly outputting light uniformly and reduced manufacturing costs thereof.

One or more exemplary embodiment of the invention provides a display device including: a backlight assembly which generates and outputs; and a display panel which displays an image with the light from the backlight assembly.

In an exemplary embodiment, the backlight assembly includes: a light emitting unit which generates the light; a light guide plate which guides the light provided from the light emitting unit toward the display panel and includes a protruding part which protrudes laterally from the light guide plate at a first corner thereof; and a reflective member which is on a surface of the protruding part and reflects the light provided from the light emitting unit and toward the protruding part, toward a second corner of the light guide plate and the periphery of the second corner.

In an exemplary embodiment of the invention, a display device includes: a backlight assembly which generates and outputs light; and a display panel which displays an image with the light from the backlight assembly.

In an exemplary embodiment, the backlight assembly includes: a light emitting unit which generates the light; a light guide plate which guides the light provided from the light emitting unit toward the display panel and includes two lateral surfaces which define a first corner of the light guide plate in a plan view of the light guide plate.

In an exemplary embodiment, the light emitting unit includes: a printed circuit board overlapping the first corner of the light guide plate in a plan view; and a plurality of light emitting diodes which is on the printed circuit board and provides the light toward the light guide plate through the two lateral surfaces which define the first corner.

### BRIEF DESCRIPTION OF THE DRAWINGS

The accompanying drawings are included to provide a further understanding of the invention, and are incorporated in and constitute a part of this disclosure. The drawings illustrate exemplary embodiments of the invention and, together with the description, serve to explain principles of the invention. In the drawings:

FIG. 1 is an exploded perspective view of an exemplary embodiment of a display device according to the invention;

FIG. 2A is a cross-sectional view taken along line I-I′ of FIG. 1;

FIG. 2B is an exploded perspective view showing an exemplary embodiment of a coupling of a light emitting unit, a light guide plate, a reflective member and a display panel shown in FIG. 1;

FIG. 3 is a plan view illustrating an exemplary embodiment of a distribution of light incident with respect to the light guide plate of FIG. 2B;

FIG. 4 is a plan view illustrating another exemplary embodiment of a light guide plate and a light emitting unit according to the invention;

FIG. 5 is a plan view illustrating still another exemplary embodiment of a light guide plate and a light emitting unit according to the invention;

FIG. 6A is a cross-sectional view of another exemplary embodiment of a display device according to the invention;

FIG. 6B is an exploded perspective view showing an exemplary embodiment of a coupling of a light emitting unit, a light guide plate, a reflective member and a display panel shown in FIG. 6A;

FIG. 7A is a cross-sectional view of still another exemplary embodiment of a display device according to the invention;

FIG. 7B is an exploded perspective view showing an exemplary embodiment of a coupling of a light emitting unit, a light guide plate, a reflective member, a display panel and a receiving container shown in FIG. 7A;

FIG. 8A is an exploded perspective view showing another exemplary embodiment of a coupling of a light emitting unit, a light guide plate and a display panel according to the invention; and

FIG. 8B is a plan view illustrating an exemplary embodiment of a distribution of light incident to the light guide plate of FIG. 8A.

### DETAILED DESCRIPTION

Hereinafter, exemplary embodiments will be described in more detail with reference to the accompanying drawings. The purposes, features and effects of the invention may be easily understood through the exemplary embodiments related to the accompanying drawings. The invention may, however, be embodied in many different forms and should not be construed as being limited to the exemplary embodiments set forth herein.

Rather, these exemplary embodiments are provided so that this disclosure will be thorough and complete, and will fully convey the invention to those skilled in the art. Accordingly, the invention should not be construed as being limited to the exemplary embodiments set forth herein. Furthermore, like reference numerals refer to like elements throughout.

It will be understood that when an element or layer is referred to as being “on,” “connected to” or “coupled to” another element or layer, the element or layer can be directly on, connected or coupled to another element or layer or intervening elements or layers. In contrast, when an element is referred to as being “directly on,” “directly connected to” or “directly coupled to” another element or layer, there are no intervening elements or layers present. As used herein, connected may refer to elements being physically and/or electrically connected to each other. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

Spatially relative terms, such as “lower,” “under,” “above,” “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used in this specification, specify the presence of stated features, integers, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

In order to reduce a manufacturing cost of a display device including a non self-emissive display panel and a backlight assembly, a number of light emitting diode (“LED”) packages mounted on a printed circuit substrate of the backlight assembly may be reduced and/or a length of the printed circuit substrate may be decreased. However, reducing the number of LED packages and/or decreasing the length of the printed circuit substrate may undesirably reduce uniformity of light output from the backlight assembly. Therefore, there remains a need for an improved structure of the backlight assembly in order to provide the uniform luminance of the light outputted from the backlight assembly.

Hereinafter, the invention will be described in detail with reference to the accompanying drawings.

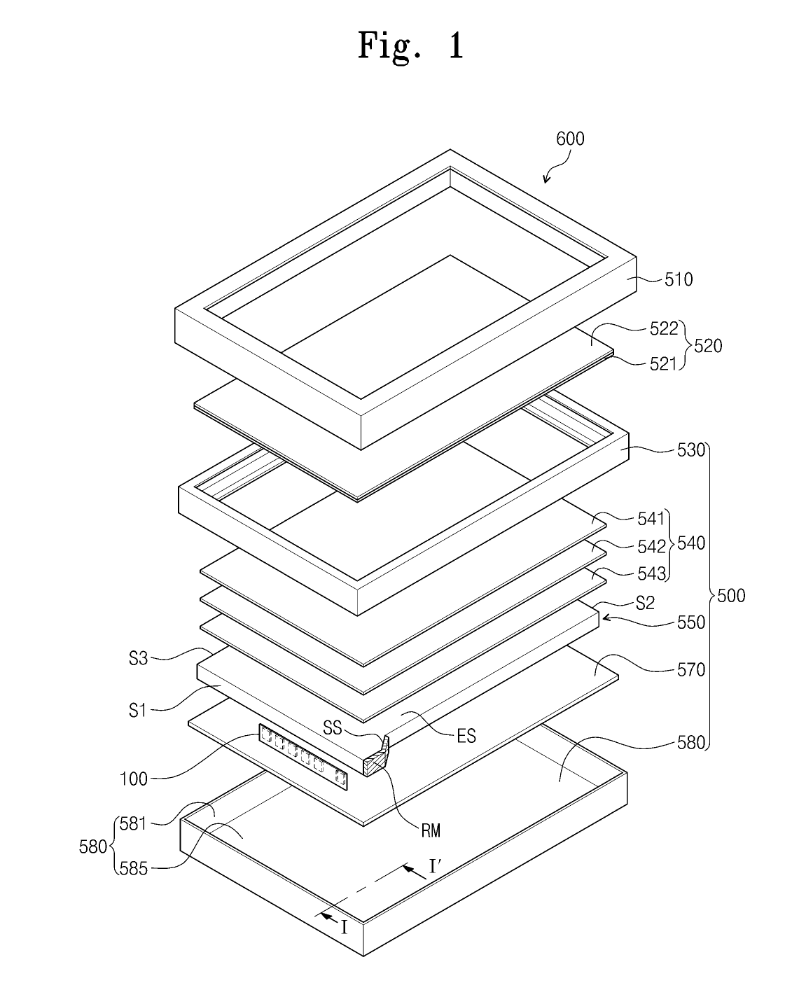

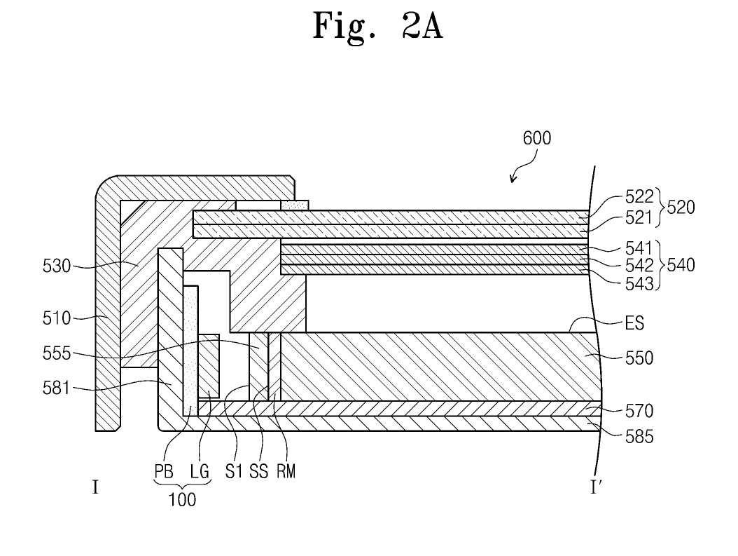

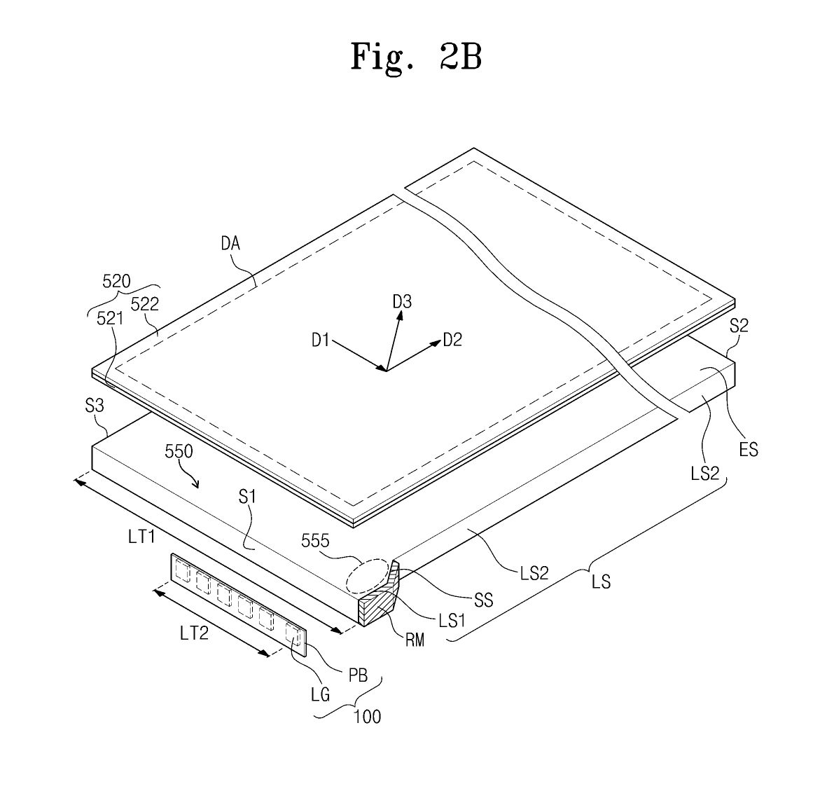

FIG. 1 is an exploded perspective view of an exemplary embodiment of a display device according to the invention. FIG. 2A is a cross-sectional view taken along line I-I′ of FIG. 1. FIG. 2B is an exploded perspective view showing an exemplary embodiment of a coupling of a light emitting unit, a light guide plate, a reflective member and a display panel shown in FIG. 1.

Referring to FIGS. 1, 2A and 2B, a display device 600 includes a backlight assembly 500 and a display panel 520. The backlight assembly 500 generates and outputs light, and the display panel 520 receives the light from the backlight assembly 500 and displays an image in a display area DA.

According to an exemplary embodiment of the invention, the display panel 520 may be a liquid crystal display panel. The display panel 520 may include a first substrate 521 including a plurality of pixel electrodes, a second substrate 522 including a common electrode facing the plurality of pixel electrodes, and a liquid crystal layer (not shown) between the first substrate 521 and the second substrate 522. However, the invention is not limited to the liquid crystal type of the display panel 520. In another exemplary embodiment, for example, the display device 600 may include the display panel 520 as a self-emitting display panel such as employed in an electrowetting display device and a nano-crystal display device.

The backlight assembly 500 includes a light emitting unit 100, a receiving container 580, a reflective plate 570, a light guide plate 550, a mold frame 530, a plurality of sheets 540 and a cover member 510.

The light emitting unit 100 generates light. According to an exemplary embodiment of the invention, the light emitting unit 100 may include a printed circuit board PB, and a plurality of light sources such as light emitting diodes LG mounted on the printed circuit board PB to generate the light. The printed circuit board PB may be elongated to extend along a first surface S1 of the light guide plate 550. Accordingly, light generated from the plurality of light emitting diodes LG may be incident toward the light guide plate 550 through the first surface S1.

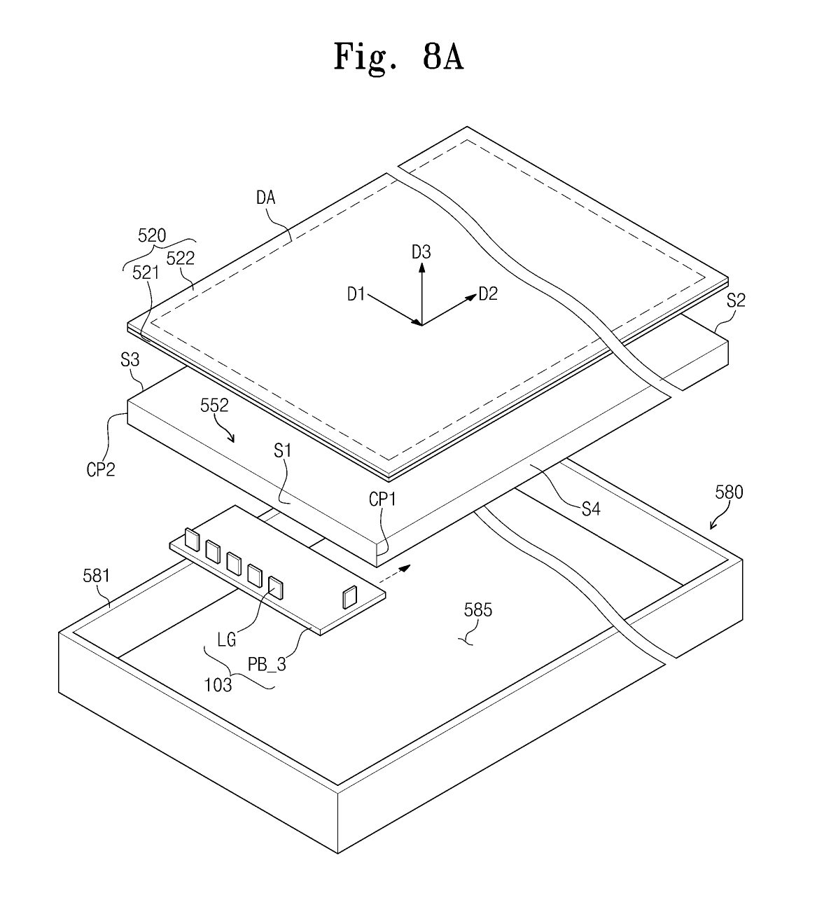

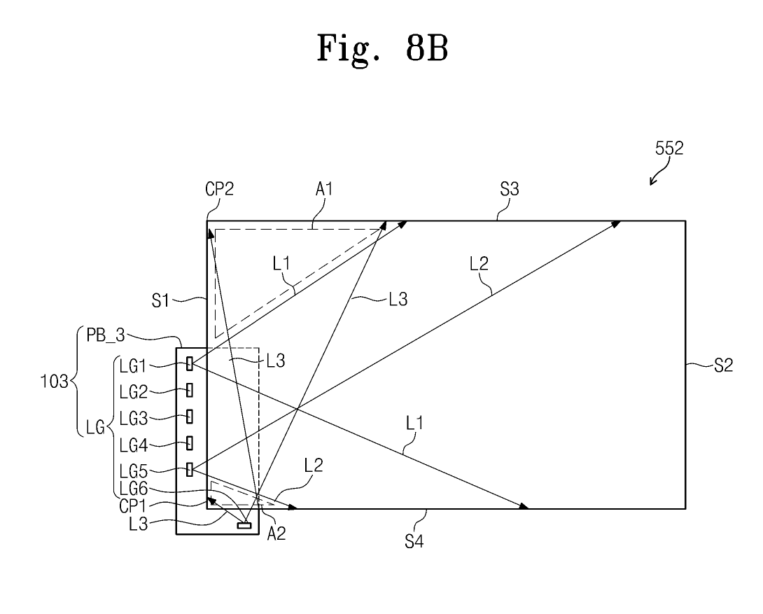

In the illustrated exemplary embodiment, the printed circuit board PB may be disposed vertical to the light guide plate 550. However, unlike the illustrated exemplary embodiment, as shown in FIG. 8A, the printed circuit board PB may be disposed horizontal to the light guide plate 550.

The receiving container 580 is equipped with a bottom 585, and a plurality of sidewalls 581 extending from the bottom 585 so as to define a receiving space in which the components of the backlight assembly 500 are received. As mentioned above, when the printed circuit board PB is disposed adjacent to the first surface S1 of the light guide plate 550, the light emitting unit 100 may be disposed between the sidewall 581 facing the first surface S1 among the plurality of sidewalls 581, and the first surface S1.

The light guide plate 550 receives light generated from the light emitting unit 100 and guides the received light toward the display panel 520. In more detail, the light generated from the light emitting unit 100 is incident to an inside of the light guide plate 550 through the first surface S1, and then, the light incident to the inside of the light guide plate 500 is emitted from the light guide plate 550 through an emitting surface ES. The light guide plate 550 may be substantially rectilinear in shape, including a pair of opposing long sides and a pair of opposing short sides. In the illustrated exemplary embodiment, the light guide plate 550 may include a protruding part 555. The protruding part 555 may protrude laterally from a lateral surface or edge of the light guide plate 550.

In addition to the first surface S1 and the emitting surface ES, the light guide plate 550 may further include a second surface S2 opposing and facing the first surface S1, a third surface S3, and a connection surface LS including an inclined surface SS with respect to the first surface S1. In the illustrated exemplary embodiment, the first to third surfaces S1, S2 and S3 and the connection surface LS may collectively be the lateral surfaces of the light guide plate 550. The inclined surface SS may be a surface of the protruding part 555. The connection surface LS may be sequentially disposed in a second direction D2 between the first surface S1 and the second surface S2 to connect the first surface S1 to the second surface S2 to each other. The third surface S3 faces the connection surface LS.

According to an exemplary embodiment of the invention, the connection surface LS may include a first connection surface LS1, the inclined surface SS and a second connection surface LS2. The first connection surface LS1, the inclined surface SS and the second connection surface LS2 are sequentially arranged in the second direction D2 between the first surface S1 and the second surface S2. That is, in the connection surface LS, the first connection surface LS 1 is adjacent and connected to the first surface S1, the second connection surface LS2 is adjacent and connected to the second surface S2, and the inclined surface SS connects the first connection surface LS1 to the second connection surface LS2 to each other.

According to an exemplary embodiment of the invention, each of the first surface S1 and the second surface S2 is elongated parallel to a first direction D1 on a plane, and each of the first and second connection surfaces LS 1 and LS2 is elongated parallel to the second direction D2 that is substantially vertical to the first direction D1 on the plane. Additionally, the inclined surface SS is elongated parallel to a third direction D3 different from the first and second directions D1 and D2 on the plane. The inclined surface SS of the protruding part 555 spaces the protruding part 555 from the display area DA on the plane, such as in the first direction D1. Moreover, the first surface S1 makes an acute angle with the inclined surface SS on the plane, and the acute angle may be defined by rotating clockwise from the first surface S1 to the inclined surface SS.

In addition, according to an exemplary embodiment of the invention, the plurality of light emitting diodes LG is arranged along the first surface S1. When the distance between the first arranged light emitting diode LG and the last arranged light emitting diode LG on the plane among the plurality of light emitting diodes LG is defined as a first separation distance LT2 and the length of the first surface S1 is defined as a first length LT1 on the plane, the first separation distance LT2 is less than the first length LT1.

Additionally, since the printed circuit board PB may have a length corresponding approximately to the first separation distance LT2, the length of the printed circuit board PB may be less than the first length LT1 of the first surface.

Accordingly, if the printed circuit board PB is a relatively expensive metal core printed circuit board (“MCPCB”), since the printed circuit board PB does not need to have a length corresponding to the first length LT1 of the first surface S1, manufacturing costs of the printed circuit board PB may be reduced, and also the number of the light emitting diodes LG disposed on the printed circuit board PB may be decreased.

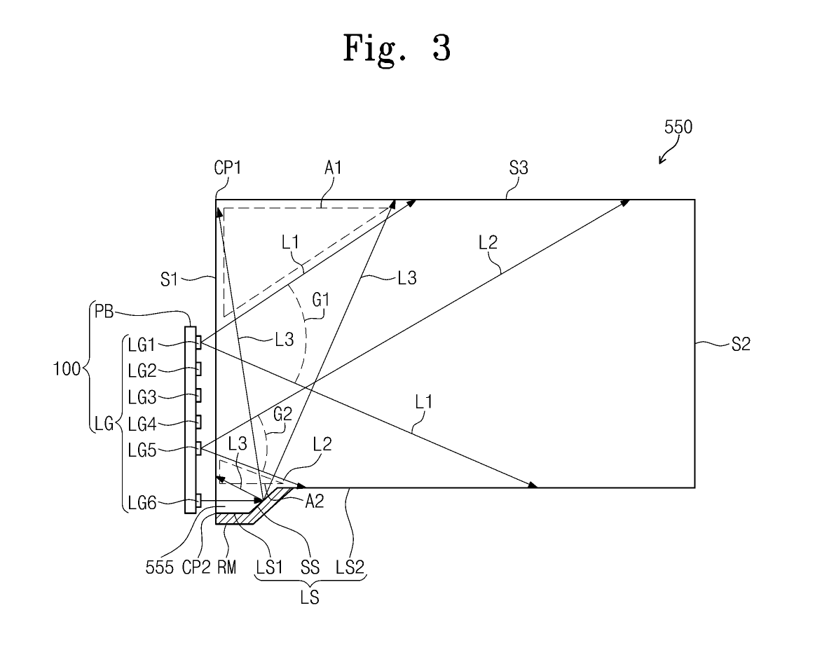

A reflective member RM is disposed on a lateral surface of the light guide plate 550 at the protruding part 555. In more detail, the reflective member RM may be disposed on the inclined surface SS. Accordingly, light generated from the light emitting unit 100 and sequentially transmitted through the first surface S1 and the inclined surface SS is reflected at the reflective member RM and then, provided to a corner of the light guide plate 555 and the periphery of the corner. Accordingly, as the reflective member RM is disposed on the inclined surface SS, a difference between the light intensity provided to the corner of the light guide plate 550 and the periphery of the corner and the light intensity provided to remaining portions of the light guide plate 550 may be reduced. This will be described in more detail with reference to FIG. 3.

According to an exemplary embodiment of the invention, the reflective member RM may be further disposed on the first connection surface LS1 connecting the first surface S1 and the inclined surface SS.

Moreover, according to an exemplary embodiment of the invention, the reflective member RM may be a reflective tape. The reflective tape may include a base member coated with a reflective material such as silver (Ag) and aluminum (Al), or with a light reflecting material such as white polyethylene terephthalate (“PET”) and poly carbonate (“PC”), in order to have a reflective surface like a mirror.

Moreover, according to another exemplary embodiment of the invention, the reflective member RM may be a reflective layer disposed on the inclined surface SS. In one exemplary embodiment of manufacturing the display device, the reflective layer may be provided (e.g., formed) by depositing a material having excellent light reflectivity such as aluminum (Al) on the lateral inclined surface SS of the light guide plate 550, or by applying a white acrylic based material on the lateral inclined surface SS of the light guide plate 550.

The reflective plate 570 may be disposed between the bottom 585 of the receiving container 580 and the light guide plate 550, and may include a light reflecting material such as PET and Al. Accordingly, light generated from the light emitting unit 100 and not incident toward the light guide plate 550 may be incident to the light guide plate 550 after being reflected by the reflective plate 570.

The mold frame 530 is coupled to the receiving container 580 so as to support the edge of the light guide plate 550 in a direction toward the bottom 585 of the receiving container 580 and restrict movement of the light guide plate 550 in a direction away from the bottom 585. A portion of the mold frame 530 extends in a direction parallel to the bottom 585 of the receiving container 580, so that the plurality of sheets 540 and the display panel 520 may be seated on the portion of the mold frame 530.

The plurality of sheets 540 is disposed between the display panel 520 and the light guide plate 550. The plurality of sheets 540 may include optical sheets adjusting the path of light emitted from the light guide plate 550 and incident toward the display panel 520. According to an exemplary embodiment of the invention, the plurality of sheets 540 may include an upper diffusion sheet 541 and a lower diffusion sheet 543 diffusing light emitted from the light guide plate 550, and a prism sheet 542 condensing the light emitted from the light guide plate 550.

An open portion is defined in the cover member 510 and exposes the display area DA of the underlying display panel 520. The cover member 510 is coupled to the receiving container 580 by covering a border or an outer edge of the display panel 520. As the cover member 510 is coupled to the receiving container 580, components of the backlight assembly 500 may be stably received in a receiving space of the receiving container 580.

FIG. 3 is a plan view illustrating an exemplary embodiment of a distribution of light incident with respect to the light guide plate of FIG. 2B.

Referring to FIG. 3, the light emitting unit 100 may include a printed circuit board PB, and the plurality of light emitting diodes LG mounted on the printed circuit board PB. The plurality of light emitting diodes LG may be arranged to face the first surface S1 of the light guide plate 550, so that light generated from the plurality of light emitting diodes LG is incident toward the light guide plate 550 through the first side S1.

In the illustrated exemplary embodiment, under the assumption that the number of the light emitting diodes LG is six, the first arranged light emitting diode to the last arranged light emitting diode among the six light emitting diodes LG are sequentially defined as first to sixth light emitting diodes LG1, LG2, LG3, LG4, LG5 and LG6, respectively.

In the illustrated exemplary embodiment, an angle at which light emitted from each of the first to sixth light emitting diodes LG1, LG2, LG3, LG4, LG5 and LG6 is radiated is the same, and the angle may be about 100° to about 150° in a plan view. In one exemplary embodiment, for example, a size of each of a first radiation angle G1 at which a first light L1 generated from the first light emitting diode LG1 is radiated and a second radiation angle G2 at which a second light L2 generated from the fifth light emitting diode LG5 is radiated may be about 100° to about 150° and in more detail, may be about 120°.

Accordingly, a range in which light generated from the second to fourth light emitting diodes LG2, LG3 and LG4 between the first and fifth light emitting diodes LG1 and LG5 is radiated in the light guide plate 550 may be within a range in which light generated from the first and fifth light emitting diodes LG1 and LG5 is radiated in the light guide plate 550.

The sixth light emitting diode LG6, which is the closest to the protruding part 555 of the light guide plate 550 among the plurality of light emitting diodes LG, faces the reflective member RM, with the protruding part 555 therebetween. Accordingly, a third light L3 generated from the sixth light emitting diode LG6 sequentially passes through the first surface S1 and the inclined surface SS of the light guide plate 550, and then is reflected by the reflective member RM and proceeds to the first corner CP1 of the light guide plate 550 and the periphery of the first corner CP1. If the first corner CP1 and the periphery of the first corner CP1 are defined as a first portion A1 indicated by the dotted line triangle in FIG. 3, light intensity provided toward the first portion A1 may be increased by the third light L3 proceeding along the above-described path. The first corner CP1 in the light guide plate 550 is defined as a portion where the first surface S1 and the third surface S3 meet.

In addition, unlike the illustrated exemplary embodiment, when the light emitting unit 100 only includes the first to fifth light emitting diodes LG1, LG2, LG3, LG4 and LG5, in consideration of a range in which light generated from the first to fifth light emitting diodes LG1, LG2, LG3, LG4 and LG5 is radiated in the light guide plate 550, a first light intensity provided to the first portion A1 of the light guide plate 550 may be less than a second light intensity provided to the remaining portions of the light guide plate 550. However, according to one or more exemplary embodiment of the invention, since the light emitting unit 100 includes the sixth light emitting diode LG6, the protruding part 555 of the light guide plate 550 including the inclined surface SS and the reflective member RM thereon, the first light intensity may be supplemented by the third light L3 proceeding along the above-described path. Therefore, a difference between the first light intensity provided to the first portion A1 of the light guide plate 550 and the second light intensity provided to the remaining portions of the light guide plate 550 may be minimized.

In addition, unlike the illustrated exemplary embodiment, when the light emitting unit 100 only includes the first to fifth light emitting diodes LG1, LG2, LG3, LG4 and LG5, in consideration of a range in which light generated from the first to fifth light emitting diodes LG1, LG2, LG3, LG4, and LG5 is radiated in the light guide plate 550, a third light intensity provided to a second portion A2, which is defined as a second corner CP2 of the light guide plate 550 and the periphery of the second corner CP2, may be less than the first light intensity. However, according to one or more exemplary embodiment of the invention, since the light emitting unit 100 includes the sixth light emitting diode LG6, the protruding part 555 of the light guide plate 550 including the inclined surface SS and the reflective member RM thereon, and since the third light L3 generated from the sixth light emitting diode LG6 is radiated at about 100° to about 160° and then is reflected at the reflective member RM, a portion of the reflected third light L3 may be provided toward the second portion A2 to supplement the third light intensity.

If the above-mentioned contents are summarized, according to one or more exemplary embodiment of the invention, a difference between light intensity provided to the first and second portions A1 and A2 at opposing light incident surface corners of the light guide plate 550 and light intensity provided to a remaining portion of the light guide plate 550 other than the first and second portions A1 and A2 is minimized, so that light intensity outputted over an entire area of the light guide plate 550 may be uniform.

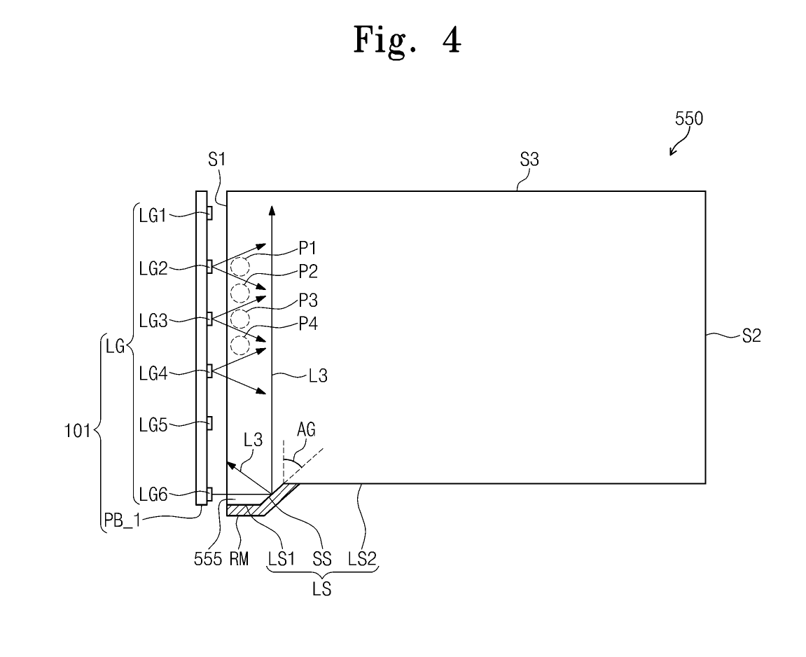

FIG. 4 is a plan view illustrating another exemplary embodiment of a light guide plate and a light emitting unit according to the invention. Referring to FIG. 4, a light emitting unit 101 outputting light and the light guide plate 550 to which the light is incident are shown. The light emitting unit 101 may replace the light emitting unit 100 of FIG. 1 in the display device 600 of FIG. 1. Accordingly, while FIG. 4 is described, overlapping descriptions are omitted.

Referring to FIG. 4, the light emitting unit 101 may include a printed circuit board PB_{—}1, and the plurality of light emitting diodes LG mounted on the printed circuit board PB_{—}1. In the illustrated exemplary embodiment, the plurality of light emitting diodes LG are sequentially arranged from one side (e.g., at the third surface S3) to an opposing side (e.g., at a fourth surface S4) of the first surface S1 of the light guide plate 550 in the plan view.

Unlike the illustrated exemplary embodiment, if the light emitting unit 101 only includes the first to fifth light emitting diodes LG1, LG2, LG3, LG4 and LG5, light generated from each of the first to fifth light emitting diodes LG1, LG2, LG3, LG4 and LG5 is provided to the light guide plate 550 at a radiation angle of about 100° to about 150°. If light intensity provided to each of portions corresponding to the positions of the first to fifth light emitting diodes LG1, LG2, LG3, LG4 and LG5, like a first portion P1 and a third portion P3 shown in FIG. 4, is defined as a first light intensity, and light intensity provided to each of portions corresponding to an area between two adjacent light emitting diodes LG among the first to fifth light emitting diodes LG1, LG2, LG3, LG4 and LG5, like a second portion P2 and a fourth portion P4 shown in FIG. 4, is defined as a second light intensity, the second light intensity is less than the first light intensity. However, according to one or more exemplary embodiment of the invention, since the light emitting unit 101 includes the sixth light emitting diode LG6 facing the inclined surface SS of the protruding portion 555 of the light guide plate 550, the first light intensity is supplemented by using the third light L3 generated from the sixth light emitting diode LG6 and reflected, so that a difference between the first light intensity and the second light intensity may be minimized.

Additionally, although the first light intensity in addition to the second light intensity may be increased by the third light L3, since light generated from the light emitting unit 101 is diffused at the first surface S1 as being incident to the first surface S1 in the first and third portions P1 and P3, the luminance in the first and third portions P1 and P3 may be greatly reduced. Accordingly, even if the first and second light intensities are supplemented by the third light L3, since the second light intensity is supplemented more by the third light L3 than the first light intensity, in general, the luminance over an entire area of the light guide plate 550 becomes uniform by the third light L3.

Moreover, according to the exemplary embodiment of FIG. 4, an angle AG between the inclined surface SS and the first surface S1 may be less as compared to the exemplary embodiment of FIG. 3, in order to increase the light intensity of the third light L3 provided to the second and fourth portions P2 and P4.

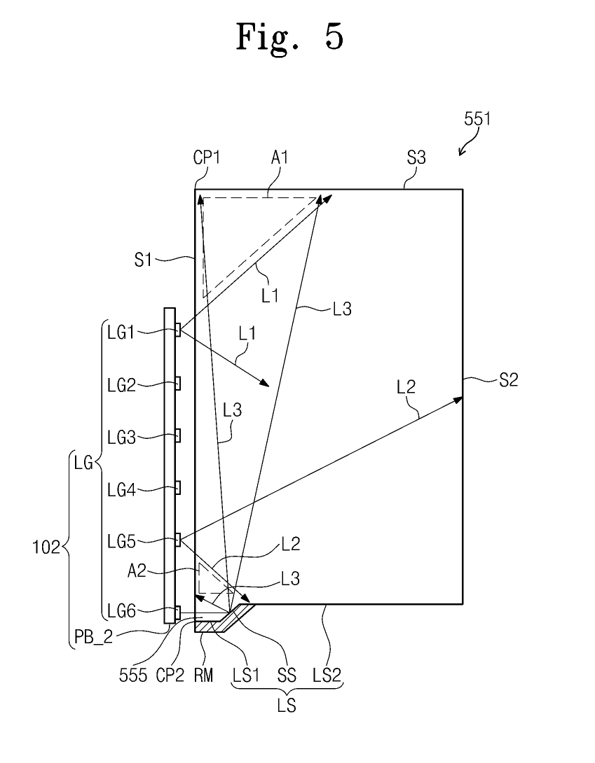

FIG. 5 is a plan view illustrating still another exemplary embodiment of a light guide plate and a light emitting unit according to the invention. Referring to FIG. 5, a light emitting unit 102 outputting light and a light guide plate 551 to which the light is incident are shown. The light emitting unit 102 may replace the light emitting unit 100 of FIG. 1 in the display device 600 of FIG. 1, and the light guide plate 551 may replace the light guide plate 550 of FIG. 1. While FIG. 5 is described, the above-mentioned components use the same reference numerals, and their overlapping descriptions will be omitted.

Referring to FIG. 5, the light emitting unit 102 includes a printed circuit board PB_{—}2, and the plurality of light emitting diodes LG mounted on the printed circuit board PB_{—}2. According to the exemplary embodiment of FIG. 1, the first surface S1 of FIG. 1 to which light is incident is defined with a short side of the light guide plate 500, but according to the exemplary embodiment of FIG. 5, the first surface S1 to which light is incident is defined with a long side of the light guide plate 551.

Like the above-described exemplary embodiments, in the illustrated embodiment of FIG. 5, the sixth light emitting diode LG6, which is the closest to the protruding part 555 among the plurality of light emitting diodes LG, is disposed to face the inclined surface SS. Accordingly, the third light L3 generated from the sixth light emitting diode LG6 sequentially passes through the first surface S1 and the inclined surface SS, and then is reflected by the reflective member RM and provided to the first and second portions A1 and A2 of the light guide plate 551. Accordingly, a uniform light intensity may be provided over the entire light guide plate 551, and therefore, light luminance outputted to the entire area of the light guide plate 551 may be uniform.

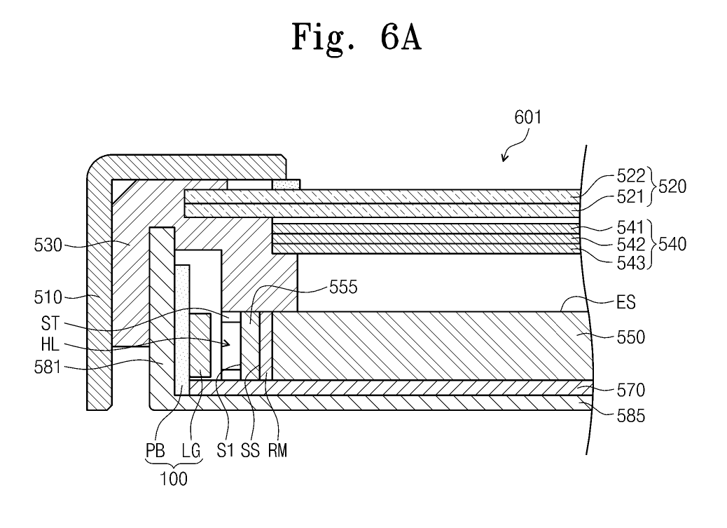

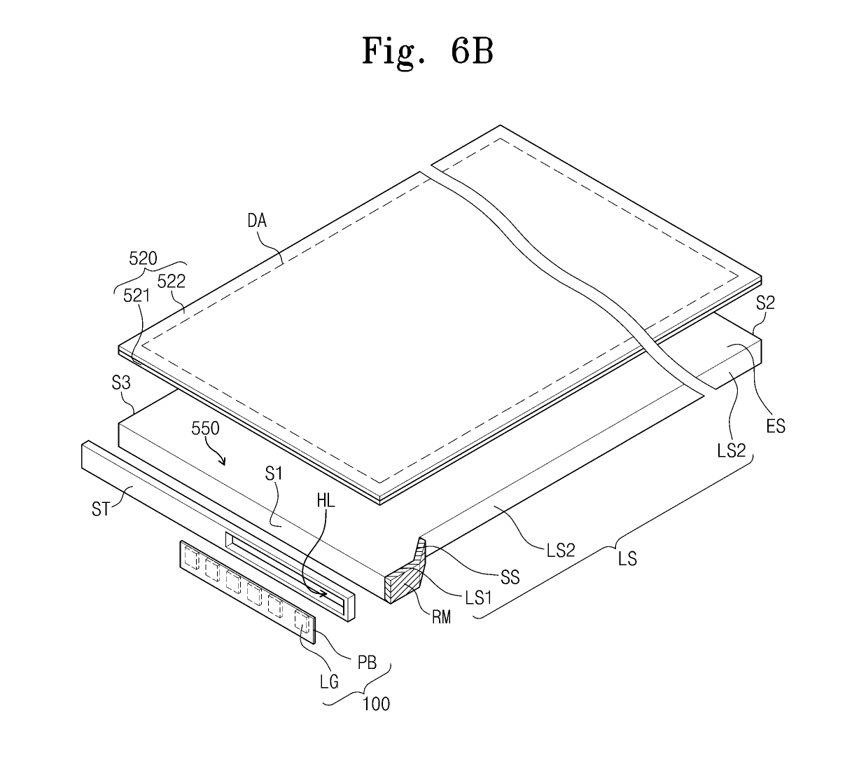

FIG. 6A is a cross-sectional view of another exemplary embodiment of a display device according to the invention. FIG. 6B is an exploded perspective view showing an exemplary embodiment of a coupling of a light emitting unit, a light guide plate, a reflective member and a display panel of FIG. 6A. The display device 601 shown in the FIGS. 6A and 6B further includes a separation member ST as a component compared to the display device 600 shown in FIGS. 1 and 2A which does not include a separation member. Accordingly, while FIGS. 6A and 6B are described, the components described with reference to FIGS. 1, 2A, 2B and 3 use the same reference numerals, and their overlapping descriptions will be omitted.

Referring to FIGS. 6A and 6B, according to the illustrated embodiment, the display device 601 further includes the separation member ST. The separation member ST is disposed between the light emitting unit 100 and the light guide plate 550, thereby maintaining an interval between the light emitting unit 100 and the light guide plate 550. Additionally, one or more through hole HL may be defined in the separation member ST in correspondence to a position of the plurality of light emitting diodes LG. Accordingly, light generated from the plurality of light emitting diodes LG may be incident to the first surface 51 of the light guide plate 550 through the through hole HL. The through hole HL may be a single enclosed opening defined in the separation member ST corresponding to the group of light emitting diodes LG. Alternatively, a plurality of through holes HL may be defined in the separation member ST, each of the through holes HL corresponding to one or more of the light emitting diodes LG.

In the illustrated exemplary embodiment, the separation member ST may include an insulating material such as silicon. Accordingly, heat generated from the printed circuit board PB is not transferred toward the light guide plate 550, so that the deformation of the light guide plate 550 may be reduced or effectively prevented.

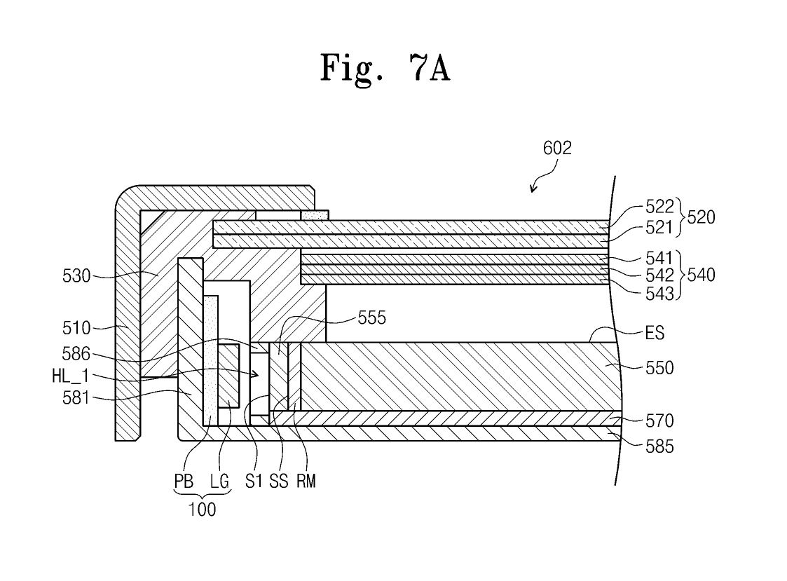

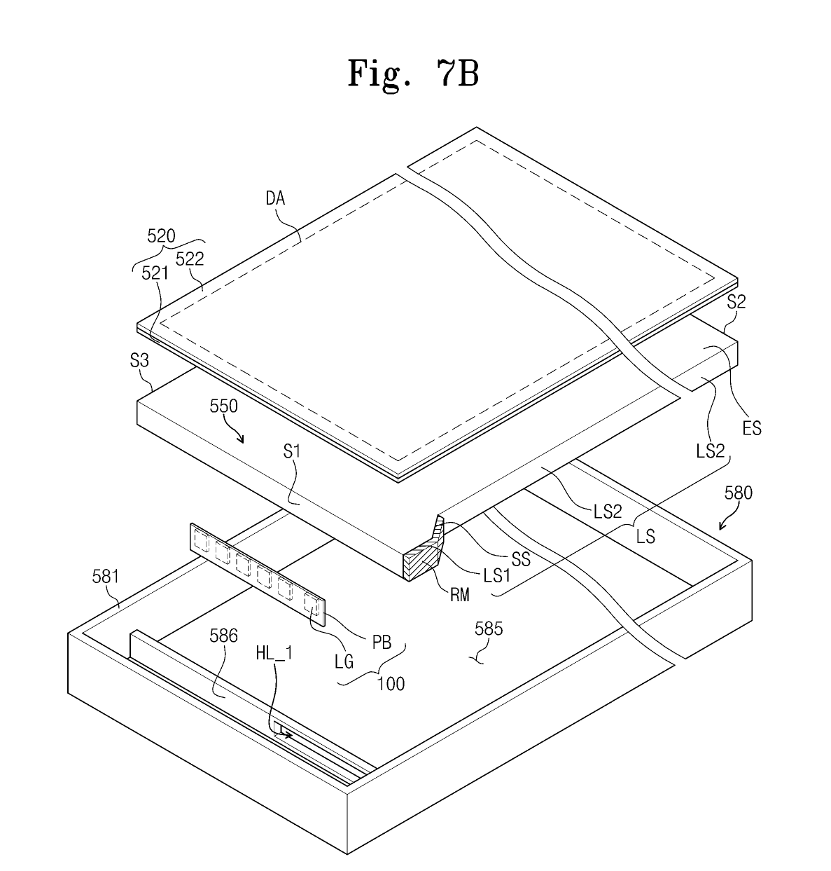

FIG. 7A is a cross-sectional view of still another exemplary embodiment of a display device according to the invention. FIG. 7B is an exploded perspective view showing an exemplary embodiment of a coupling of a light emitting unit, a light guide plate, a reflective member, a display panel and a receiving container of FIG. 7A The display device 602 shown in the FIGS. 7A and 7B further includes a separation member 586 as a component compared to the display device 600 shown in FIGS. 1 and 2A which does not include a separation member.

Accordingly, while FIGS. 7A and 7B are described, the components described with reference to FIGS. 1, 2A, 2B, and 3 use the same reference numerals, and their overlapping descriptions will be omitted.

Referring to FIGS. 7A and 7B, according to the illustrated exemplary embodiment, the display device 602 further includes the separation member 586. The separation member 586 is disposed between the light emitting unit 586 and the light guide plate 550, thereby maintaining an interval between the light emitting unit 100 and the light guide plate 550. Additionally, a through hole HL may be defined in the separation member 586 in correspondence to a position of the plurality of light emitting diodes LG. Accordingly, light generated from the plurality of light emitting diodes LG may be incident to the first surface 51 of the light guide plate 550 through the through hole HL_{—}1.

In the illustrated exemplary embodiment, the separation member 586 may be elongated to extend from the bottom 585 of the receiving container 580 and be horizontal to the sidewalls 581 of the receiving container 580. The separation member 586 may contact the bottom 585. Accordingly, heat generated from the printed circuit board PB is not transferred toward the light guide plate 550, and is transferred to the separation member 586, so that the heat may be easily emitted to outside the backlight assembly 500 through the receiving container 580. Therefore, the deformation of the light guide plate 550 due to the heat may be reduced or effectively prevented.

FIG. 8A is an exploded perspective view showing another exemplary embodiment of a coupling of a light emitting unit, a light guide plate and a display panel. FIG. 8B is a plan view illustrating an exemplary embodiment of a distribution of light incident to the light guide plate of FIG. 8A. Except for the light guide plate 552 and the light emitting unit 103, the backlight assembly shown in FIGS. 8A and 8B has the same configuration as the backlight assembly 500 of FIG. 1. Accordingly, while FIGS. 8A and 8B are described, the structures of the light guide plate 552 and the light emitting unit 103 are mainly described. In addition, the remaining components use the same reference numerals, and their overlapping descriptions will be omitted.

Referring to FIGS. 8A and 8B, the light emitting unit 103 may include a printed circuit board PB_{—}3, and the plurality of light emitting diodes LG mounted on the printed circuit board PB_{—}3.

In the illustrated exemplary embodiment, the printed circuit board PB_{—}3 is disposed horizontal to the light guide plate 552, and accordingly, may be disposed between the light guide plate 552 and the bottom 585 of the receiving container 580 in a cross-sectional view.

In the illustrated exemplary embodiment, the printed circuit board PB_{—}3 may overlap the first corner CP1 a portion A2 of the light guide plate 552. The light guide plate 552 includes the first surface 51, the second surface S2 facing the first surface 51, a third surface, and a fourth surface S4 facing the third surface S3. The first corner CP1 may be defined when the first surface 51 and the fourth surface S4 meet, and the second corner CP2 may be defined when the first surface 51 and the third surface S3 meet.

In the illustrated exemplary embodiment, more than one light emitting diode among the plurality of light emitting diodes LG may face the first surface 51, and only one light emitting diode among the plurality of light emitting diodes LG may face the fourth surface S4. In one exemplary embodiment, for example, when it is assumed that the plurality of light emitting diodes LG include the first to sixth light emitting diodes LG1, LG2, LG3, LG4, LG5 and LG6, the first to fifth light emitting diodes LG1, LG2, LG3, LG4 and LG5 face the first surface S1 and the sixth light emitting diode LG6 faces the fourth surface S4. Where the plurality of light emitting diodes LG faces more than one lateral side surface of the light guide plate 550, the first surface S1 is elongated to extend in the first direction D1 and the fourth surface S4 is elongated to extend in the second direction D2 that is substantially vertical to the first direction D1, so that each of the first to fifth light emitting diodes LG1, LG2, LG3, LG4 and LG5 may be disposed in a direction substantially vertical to the sixth light emitting diode LG6.

According to the structures of the light guide plate 552 and the light emitting unit 103, the third light L3 generated from the sixth light emitting diode LG6 at the first corner CP1 passes through the fourth surface S4 and then, proceeds to the opposing second corner CP2 of the light guide plate 552 and the periphery of the second corner CP2. If the second corner CP2 and the periphery of the second corner CP2 are defined with the first portion A1, the first light intensity provided toward the first portion A1 may be increased by the third light L3 proceeding along the above-described path. Accordingly, a difference between the first light intensity and light intensity provided to the remaining portions of the light guide plate 552 except the first portion A1 may be reduced.

Since a radiation range of the third light L3 provided from the sixth light emitting diode LG6 includes the second portion A2 of the light guide plate 552 defined as the peripheral of the first corner CP1, light intensity provided to the second portion A2 may be supplemented by the third light L3 from the sixth light emitting diode LG6.

According to one or more exemplary embodiment of the invention, light provided to an inclined surface of a protruding part at a first corner of a light guide plate among light incident to the light guide plate is reflected toward an opposing second corner of the light guide plate by a reflective member. Accordingly, since light intensity provided to the opposing second corner of the light guide plate can be supplemented, reduced light intensity at the opposing second corner due to the placement of a light emitting unit may be reduced or effectively prevented and light may be uniformly provided over an entire area of the light guide plate. Additionally, the display quality of a display device, which displays an image by using light outputted from a backlight assembly including a light guide plate with the above structure, may be improved.

Additionally, as mentioned above, since light intensity provided to the opposing second corner of the light guide plate is supplemented by using the reflective member, the light emitting unit does not need to be placed at the opposing second corner of the light guide plate. Accordingly, since the number of light emitting diodes in the light emitting unit of the backlight assembly is decreased and the length of a printed circuit board upon which the light emitting diodes are mounted is reduced, manufacturing costs of the backlight assembly and a display device including the same may be reduced.

Moreover, according to another exemplary embodiment of the invention, even if light intensity inputted to the light guide plate becomes less with respect to an area between adjacent light emitting diodes because an interval between light emitting diodes of a light emitting unit is increased, light intensity is supplemented to the area of the light guide plate between the adjacent light emitting diodes by using the light reflected at the reflective member and proceeding toward the opposing second corner of the light guide plate.

Additionally, according to another exemplary embodiment of the invention, a printed circuit board may be disposed in parallel to a plane of a light guide plate to overlap a corner of the light guide plate in the plan view. A plurality of light emitting diodes may be disposed on the printed circuit board to face adjacent lateral surfaces each elongated in different directions and defining a first corner of the light guide plate. Accordingly, light may be easily provided to an opposing second corner side facing the first corner by using the plurality of light emitting diodes. Therefore, since the printed circuit board and the plurality of light emitting diodes do not need to be disposed at the opposing second corner, manufacturing costs of a backlight assembly and a display device including the same may be reduced.

The above-disclosed subject matter is to be considered illustrative, and not restrictive, and the appended claims are intended to cover all such modifications, enhancements, and other embodiments, which fall within the true spirit and scope of the invention. Thus, to the maximum extent allowed by law, the scope of the invention is to be determined by the broadest permissible interpretation of the following claims and their equivalents, and shall not be restricted or limited by the foregoing detailed description.

What is claimed is:

1. A display device comprising:
a backlight assembly which generates and outputs light; and
a display panel which displays an image with the light from the backlight assembly,
wherein the backlight assembly comprises:
a light emitting unit which generates the light;
a light guide plate which guides the light provided from the light emitting unit toward the display panel, and comprises a protruding part which protrudes laterally from the light guide plate at a first corner thereof; and
a reflective member which is on a surface of the protruding part and reflects the light provided from the light emitting unit and toward the protruding part, toward a second corner of the light guide plate and a periphery of the second corner.

2. The display device of claim 1, wherein the light guide plate further comprises:
a first surface to which the light provided from the light emitting unit is incident,
an emitting surface which emits the incident light,
a second surface facing the first surface, and
a connection surface which connects the first surface to the second surface, and comprises an inclined surface with respect to the first surface, wherein the inclined surface is a surface of the protruding part.

3. The display device of claim 2, wherein
the light guide plate further comprises a third surface facing the connection surface, and
the second corner of the light guide plate is defined where the first surface and the third surface meet each other.

4. The display device of claim 3, wherein the first surface, the second surface, the third surface and the connection surface are lateral surfaces of the light guide plate.

5. The display device of claim 2, wherein the first surface forms an acute angle with the inclined surface of the connection surface in a plan view, and the acute angle is defined by a rotation from the first surface to the inclined surface in a clockwise direction.

6. The display device of claim 2, wherein the light emitting unit comprises:
a printed circuit board which is elongated along the first surface of the light guide plate; and
a plurality of light emitting diodes which is arranged along the first surface of the light guide plate, on the printed circuit board, and generates the light.

7. The display device of claim 6, wherein
a separation distance between a first arranged light emitting diode and a last arranged light emitting diode among the plurality of light emitting diodes is less than a length of the first surface of the light guide plate, and
a length of the printed circuit board is less than the length of the first surface of the light guide plate.

8. The display device of claim 6, wherein a light generated from a light emitting diode which is closest to the protruding part among the plurality of light emitting diodes, sequentially passes through the first surface and the inclined surface of the protruding portion, and then is reflected toward the second corner and the periphery of the second corner by the reflective member.

9. The display device of claim 6, wherein the plurality of light emitting diodes is sequentially arranged from a first end of the first surface of the light guide plate to an opposing second end of the first surface of the light guide plate.

10. The display device of claim 2, wherein the reflective member is a reflective tape on the inclined surface of the protruding portion.

11. The display device of claim 2, wherein the reflective member is a reflective layer disposed on the inclined surface of the protruding portion.

12. The display device of claim 1, wherein the display panel comprises a display area, and the protruding part is extended away from the display area in a plan view.

13. A display device comprising:
a backlight assembly which generates and outputs light; and
a display panel which displays an image with the light from the backlight assembly,
wherein the backlight assembly comprises:
a light emitting unit which generates the light, and
a light guide plate which guides the light provided from the light emitting unit toward the display panel, and comprises two lateral surfaces which define a first corner of the light guide plate in a plan view of the light guide plate,
wherein the light emitting unit comprises:
a printed circuit board overlapping the first corner of the light guide plate in the plan view; and
a plurality of light emitting diodes which is on the printed circuit board, and provides the light through the two lateral surfaces which define the first corner of the light guide plate.

14. The display device of claim 13, wherein
the two lateral surfaces of the light guide plate comprise a first lateral surface and a second lateral surface which meet each other to define the first corner of the light guide plate, and
a portion of the plurality of light emitting diodes faces the first surface, and a remaining portion of the plurality of light emitting diodes faces the second surface.

15. The display device of claim 14, wherein
the light guide plate further comprises a third lateral surface facing the first lateral surface and a fourth lateral surface facing the second lateral surface,
the first lateral surface and the fourth lateral surface meet to define a second corner of the light guide plate, and
the portion of the plurality of light emitting diodes which faces the second surface provides light to the second corner and a periphery of the second corner.

16. The display device of claim 15, wherein
more than one light emitting diode among the plurality of light emitting diodes faces the first surface of the light guide plate, and
only one light emitting diode among the plurality of light emitting diodes faces the second surface of the light guide plate.

17. The display device of claim 14, wherein
a separation distance between a first arranged light emitting diode and a last arranged light emitting diode of the portion of the plurality of light emitting diodes facing the first surface is less than a length of the first surface of the light guide plate, and
a length of the printed circuit board is less than the length of the first surface of the light guide plate.

18. The display device of claim 14, wherein the portion of the plurality of light emitting diodes facing the first surface of the light guide plate is disposed vertical to the portion of the light emitting diodes facing the second surface of the light guide plate.

19. The display device of claim 13, further comprising a receiving container which receives the light guide plate and the light emitting unit, and comprises a bottom, and sidewalls extending from the bottom,
wherein the printed circuit board is disposed between the light guide plate and the bottom of the receiving container, in a cross-sectional view.
